(19) United States
(12) Patent Application Publication
(10) Pub. No.: US 2008/0279051 A1
(43) Pub. Date: Nov. 13, 2008

(54) Portable article with alert timer

(76) Inventors: Marina Ling Chen, Los Angeles, CA (US); Christine Ching Yu Ko, Los Angeles, CA (US)

Correspondence Address: DAVID AND RAYMOND PATENT FIRM, 108 N. YNEZ AVE., SUITE 128, MONTEREY PARK, CA, 91754, US

(21) Appl. No.: 11/801,932

(22) Filed: May 11, 2007

(51) Int. Cl. G04F 10/00

(52) U.S. Cl. 368/109

(57) ABSTRACT

A portable article includes a portable item having a primary function and adapted for being conveniently carried by a user, and an alert timer, which is built-in with the portable item, including a time setter setting a time interval at a starting time, a time processor counting the time interval starting from the starting time, and a signal generator automatically and timely generating an alert signal in a punctual time manner when said time processor is finished counting the time interval in responsive to the starting time.

### BACKGROUND OF THE PRESENT INVENTION

1. Field of Invention

The present invention relates to an alert device, and more particular to a portable article with an alert timer, wherein the portable article not only provides a primary function but also provides an added-on alert function such that the user is able to conveniently carry the portable article and to set a time interval for the alert timer to automatically and timely generate an alert signal in a punctual time manner.

2. Description of Related Arts

As the development of economy, the work efficiency is considered of importance to us now. People always plan their schedule everyday, which creates needs of some devices automatically giving a suggested signal according to the designed time. Accordingly, the designed time is set by the user in such a manner that the user will be reminded in responsive to the scheduled time.

Accordingly, portable articles, such as watch, mobile phone, keychain, and the like, are considered as necessary items that people must carry everyday. In other words, people must carry all the portable articles and the alarm device at the same time. It is a hassle for the people to carry every single article in which each of the articles can only provide a primary function.

In order to solve the above problem, a kind of electronic or digital timepiece, such as electronic watch or electronic clock, are popular among people for a time in the world. With this kind of electronic timepiece, the user can set an alarm time and take the electronic timepiece along with him anyplace. Despite its advantages and usefulness, there are some problems with the electronic watch. Firstly, the appearance of the electronic watch is not usually good as the mechanical watch, especially not fit for adults. Secondly, the quality is not as good as the mechanical watch. In addition, the user must set the designated time but not the time interval for such electronic timepiece to generate the reminding signal. In other words, when the user wants to set the alarm 45 minutes after the current time, he or she must calculate the designated time by adding 45 minutes to the current time.

### SUMMARY OF THE PRESENT INVENTION

A main object of the present invention is to provide a portable article with an alert timer, wherein the portable article not only provides a standard function but also provides an added-on alert function such that the user is able to conveniently carry the portable article and to set a time interval for the alert timer to automatically and timely generate an alert signal in a punctual time manner. In other words, the user does not require carrying an additional alert device daily to minimize the hassle of carrying too many items at the same time.

Another object of the present invention is to provide a portable article with an alert timer, wherein the set up process is simple and easy by setting the time interval to the portable article such that the alert timer will automatically provide the current time and the alert timer will count the time in responsive to the time interval. In other words, no calculation for the user is needed to set the designated time.

Another object of the present invention is to provide a portable article with an alert timer, wherein the alert timer is adapted to incorporate with all kinds of portable article, including timepiece, PDA, mobile phone, keychain, and the like, without alternating the original structural or electronic configuration of the portable article.

Another object of the present invention is to provide a portable article with an alert timer, wherein no complicated mechanical and electronic device for the alert timer is involved in installing or incorporating with the portable article, so as to substantially reduce the cost of the portable article with the alert timer.

Accordingly, in order to accomplish the above objects, the present invention provides a portable article, comprising:

a portable item having a primary function and adapted for being conveniently carried by a user; and

an alert timer, which is built-in with the portable item, comprising a time setter setting a time interval at a starting time, a time processor counting the time interval starting from the starting time, and a signal generator automatically and timely generating an alert signal in a punctual time manner when said time processor is finished counting the time interval in responsive to the starting time.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a portable article with an alert timer according to a preferred embodiment of the present invention, illustrating the portable article being a keychain.

FIG. 2 is a block diagram of the alert timer according to the above preferred embodiment of the present invention.

FIG. 3 is a flow diagram illustrating the process of setting the time interval for the alert timer according to the above preferred embodiment of the present invention.

FIG. 4 is a perspective view of a portable article with an alert timer according to a preferred embodiment of the present invention, illustrating the portable article being a timepiece.

FIG. 5 is a perspective view of a portable article with an alert timer according to a preferred embodiment of the present invention, illustrating the portable article being a mobile phone.

### DETAILED DESCRIPTION OF THE PREFERRED EMBODIMENT

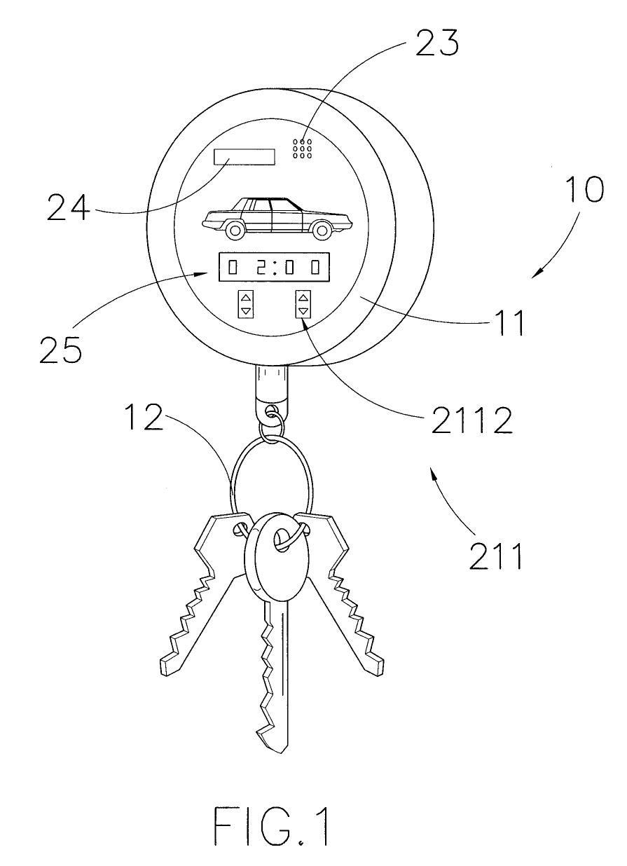

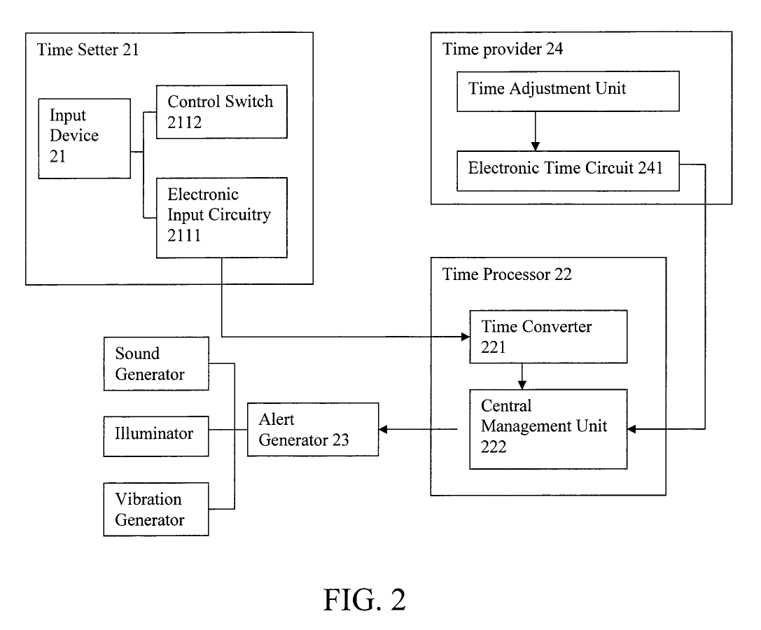

Referring to FIGS. 1 and 2 of the drawings, a portable article according to a preferred embodiment is illustrated, wherein the portable article comprises a portable item 10 and an alert timer 20.

As shown in FIG. 1, the portable item 10 has a primary function and adapted for being conveniently carried by a user. The portable item 10 is embodied as a keychain which comprises a carrying body 11 and one or more key holders 12 for securely holding keys in position as the primary function. The carrying body 11 has a receiving cavity to receive the alert timer 20 therein.

The alert timer 20, which is built-in with the portable item 10, comprises a time setter 21 setting a time interval at a starting time, a time processor 22 counting the time interval starting from the starting time, and a signal generator 23 automatically and timely generating an alert signal in a punctual time manner when the time processor 22 is finished counting the time interval in responsive to the starting time.

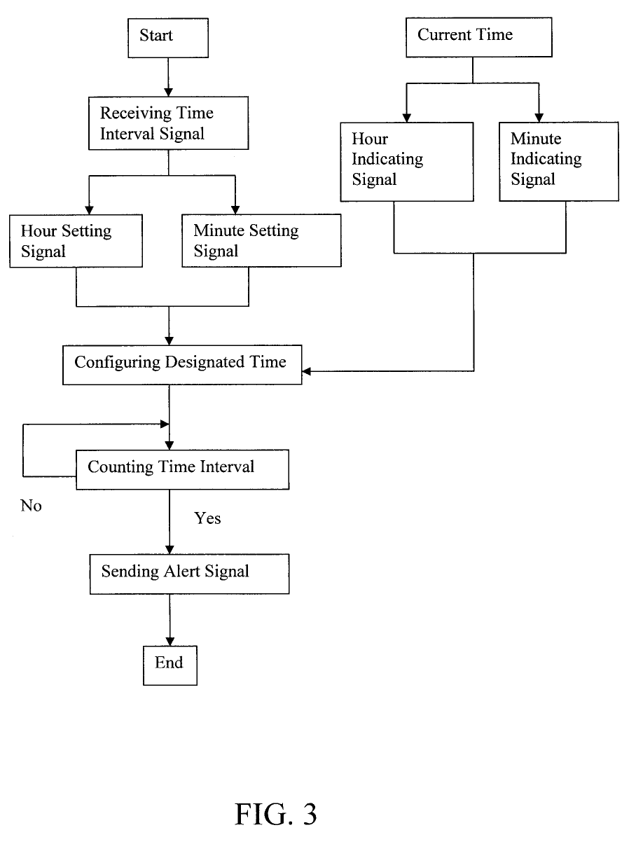

As shown in FIG. 3, the present invention further provides a method of configuring an alert of a portable article, comprising the steps of:

(1) Provide a portable item 10 for being conveniently carried by a user, wherein the alert timer 20 is built-in with the portable item 10.

(2) Set the time interval at a starting time in the alert timer 20.

(3) Count down the time interval from the starting time.

(4) Automatically and timely generate the alert signal as an added-on alert function in a punctual time manner once the time interval is over.

According to the preferred embodiment, the time setter 21 comprises an input device 211 operatively linked with the time processor 22 to input the time interval. The input device 211 comprises an electronic input circuitry 2111 supported in the receiving cavity of the carrying body 11 and a plurality of control switches 2112 spacedly provided on the carrying body 11. The control switches 2112 are electrically connected to the electronic input circuitry 2111 to input the time interval such that the electronic input circuitry 2111 receives a time interval signal in digit form as the time interval and sends the time interval signal to the time processor 22.

The time processor 22 comprises a time converter 221 converting the time interval into a hour setting signal and a minute setting signal, and a central management unit 222 configuring a designated time from the hour setting signal and the minute setting signal and sending out a time alert signal to the signal generator 23 when the designated time is reached.

Accordingly, when the time interval signal is input through the input device 211, the time interval signal is converted by the time converter 221 to form the hour setting signal and the minute setting signal in digit form. For example, when the user inputs 1 hour and 45 minutes as the time interval, the time converter 221 will convert the “1 hour” time interval as the hour setting signal and the “45 minutes” time interval as the minute setting signal. Likewise, when the user inputs 105 minutes as the time interval, the time converter 221 will automatically read the “105 minutes” and convert into the hour setting signal and the minute setting signal.

The central management unit 222 is arranged to configure the designated time when the time interval is input. Therefore, the central management unit 222 will send the time alert signal to the signal generator 23 at the designated time. In other words, the user is able to simply input the time interval in which the central management unit 222 will automatically configure the designated time.

According to the preferred embodiment, the signal generator 23 comprises a sound generator receiving in the receiving cavity of the carrying body 11 and generating a sound signal as the alert signal. Alternatively, the signal generator 23 can be an illuminator and/or a vibration generator generating a light signal and/or a vibration signal as the alert signal. It is worth to mention that the electronic watch or mobile phone generally incorporates with the built-in signal generator 23 such that the alert timer 20 of the present invention is adapted to link to the signal generator 23. Therefore, the user is able to select one or more alert signals to be generated at the designated time. In order to stop the alert signal, the user is able to manually actuate the input device 211 to deactivate the signal generator 23 and to reset the time setter 21.

As shown in FIGS. 1 and 2, the alert timer 20 further comprises a time provider 24 providing a current time and sending a current time signal to the central management unit 222 to configure the designated time in responsive to the current time. The time provider 24, which is received in the receiving cavity of the carrying body 11, comprises an electronic time circuit 241 generating a hour indicating signal and a minute indicating signal. Accordingly, when the user inputs 1 hour and 45 minutes as the time interval at the current time of 13:48, the central management unit 222 will automatically configure the designated time as 15:33 by adding 1 hour and 45 minutes to the current time. Therefore, the central management unit 222 will send the time alert signal to the signal generator 23 at the designated time of 15:33. In other words, the user does not require determining the designated time by adding the current time with the time interval.

The alert timer 20 further comprises a display screen 25, which is provided on the carrying body 11, displaying the time interval when the time interval is input. Also, the display screen 25 displays the current time.

Accordingly, when the user carries the portable article daily, the portable article not only provides a key holding function as the primary function but also allows the user to set the alert timer 20 as the supplement function. In other words, the user is able to minimize the items to be carried every day by only carrying the alert timer 20 built-in with the portable item 10.

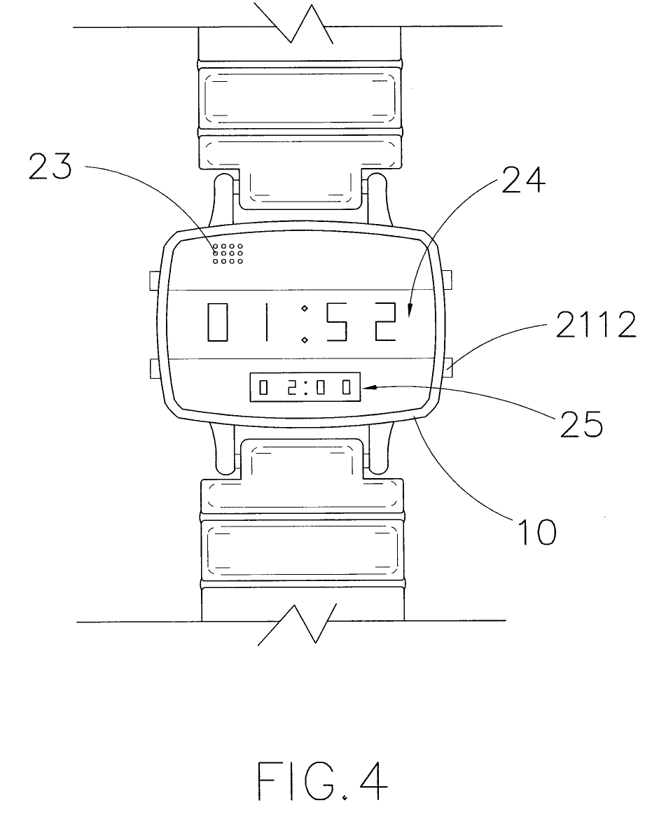

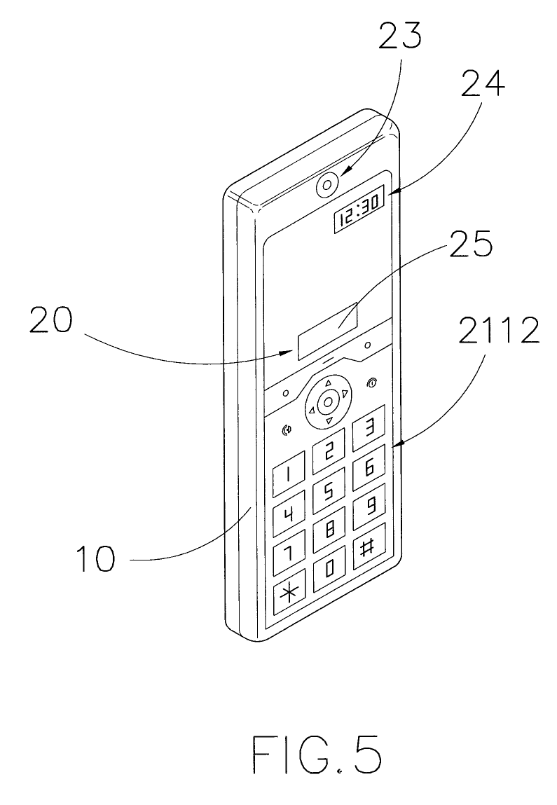

As it is mentioned above, the portable item 10 can be a timepiece or a mobile phone as shown in FIGS. 4 and 5. Since the timepiece, mobile phone, and/or PDA has a built-in time provider to provide current time and a built-in alert generator, the alert timer 20 can be simply incorporate with such portable item 10 without complicating the original configuration of the portable item 10.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable article, comprising:
a portable item having a primary function and adapted for being conveniently carried by a user; and
an alert timer, which is built-in with the portable item, comprising a time setter setting a time interval at a starting time, a time processor counting the time interval starting from the starting time, and a signal generator automatically and timely generating an alert signal in a punctual time manner when said time processor is finished counting the time interval in responsive to the starting time.

2. The portable article, as recited in claim 1, wherein said time setter comprises an input device operatively linked with said time processor to input said time interval.

3. The portable article, as recited in claim 2, wherein said input device comprises an electronic input circuitry receiving a time interval signal in digit form as said time interval and sending said time interval signal to said time processor.

4. The portable article, as recited in claim 3, wherein said input device further comprises a plurality of control switches which are provided on said portable item and are electrically linked to said electronic input circuitry to input said time interval.

5. The portable article, as recited in claim 1, wherein said time processor comprises a time converter converting said time interval into a hour setting signal and a minute setting signal, and a central management unit configuring a designated time from said hour setting signal and said minute setting signal and sending out a time alert signal to said signal generator when said designated time is reached.

6. The portable article, as recited in claim 4, wherein said time processor comprises a time converter converting said time interval into a hour setting signal and a minute setting signal, and a central management unit configuring a designated time from said hour setting signal and said minute setting signal and sending out a time alert signal to said signal generator when said designated time is reached.

7. The portable article, as recited in claim 1, wherein said signal generator comprises a sound generator generating a sound signal as said alert signal.

8. The portable article, as recited in claim 6, wherein said signal generator comprises a sound generator generating a sound signal as said alert signal.

9. The portable article, as recited in claim 8, wherein said alert timer further comprises a time provider providing a current time and sending a current time signal to said central management unit to configure said designated time in responsive to said current time.

10. The portable article, as recited in claim 1, wherein said signal generator comprises an illuminator generating a light signal as said alert signal.

11. The portable article, as recited in claim 6, wherein said signal generator comprises an illuminator generating a light signal as said alert signal.

12. The portable article, as recited in claim 11, wherein said alert timer further comprises a time provider providing a current time and sending a current time signal to said central management unit to configure said designated time in responsive to said current time.

13. The portable article, as recited in claim 1, wherein said signal generator comprises a vibration generator generating a vibration signal as said alert signal.

14. The portable article, as recited in claim 6, wherein said signal generator comprises a vibration generator generating a vibration signal as said alert signal.

15. The portable article, as recited in claim 14, wherein said alert timer further comprises a time provider providing a current time and sending a current time signal to said central management unit to configure said designated time in responsive to said current time.

16. A method of configuring an alert of a portable article, comprising the steps of:
(a) providing a portable item, which has a primary function, for being conveniently carried by a user, wherein an alert timer is built-in with said portable item;
(b) setting a time interval at a starting time in said alert timer;
(c) counting down said time interval from said starting time; and
(d) automatically and timely generating an alert signal as an added-on alert function in a punctual time manner once said time interval is over.

17. The method as recited in claim 16 wherein, in the step (b), said time interval is input through a plurality of control switches provided on said portable item.

18. The method, as recited in claim 17, wherein said alert signal is a sound signal output from said portable item.

19. The method, as recited in claim 17, wherein said alert signal is a light signal output from said portable item.

20. The method, as recited in claim 17, wherein said alert signal is a vibration signal output from said portable item.
